(19) United States
(12) Patent Application Publication
(10) Pub. No.: US 2008/0128199 A1
(43) Pub. Date: Jun. 5, 2008

(54) ACOUSTIC WAVEGUIDE AND ELECTROACOUSTIC SYSTEM INCORPORATING SAME

(75) Inventor: Roberto MAGALOTTI, Firenze (IT)

Correspondence Address: HOGAN & HARTSON LLP, ONE TABOR CENTER, SUITE 1500, 1200 SEVENTEENTH ST, DENVER, CO, 80202, US

(73) Assignee: B&C SPEAKERS S.P.A., BAGNO A RIPOLI (IT)

(21) Appl. No.: 11/939,838

(22) Filed: Nov. 14, 2007

(30) Foreign Application Priority Data
Nov. 30, 2006 (IT) RM2006A000637

(51) Int. Cl. G10K 11/18

(52) U.S. Cl. 181/185

(57) ABSTRACT

An acoustic waveguide includes an internally hollow primary body provided with an opening for an incoming acoustic radiation and an outlet opening for diffusing the radiation to the outside of said guide. The primary body defines an acoustic flared conduit for propagating the radiation between the inlet opening and the outlet opening. The waveguide further includes a plurality of acoustic discontinuity elements inside the acoustic conduit between the inlet opening and the outlet opening, and which are operative to interfere with the radiation propagating inside the acoustic conduit. The plurality of acoustic discontinuity elements include an array of spaced apart pins transverse to the acoustic conduit.

### RELATED APPLICATION

The present application claims priority of Italian Patent Application No. RM2006A000637 filed Nov. 30, 2006, which is incorporated herein in its entirety by this reference.

### FIELD OF THE INVENTION

The present invention relates to the technical field of acoustic diffusion and in particular to acoustic waveguides.

### BACKGROUND OF THE INVENTION

In the field of acoustic diffusion, in particular for professional use, the use of acoustic waveguides to be coupled to respective acoustic sources and provided with suitable means to modify the wavefronts of an acoustic radiation propagating inside the guide is known.

For example, acoustic waveguides are known, which receive an acoustic radiation input comprised of planar waves with circular wavefronts, and output acoustic radiation formed by planar waves with generally rectangular wavefronts. Such a waveguide is for example described by European Patent Application No. EP 0 331 566.

These acoustic guides are generally used in acoustic diffusion systems, so called “line-arrays”, wherein electroacoustic diffusers provided with such acoustic guides are vertically stacked on one another in order to form a linear generally coherent source, such as to reduce the dispersion of acoustic energy radiated in the vertical plane, by concentrating the acoustic energy radiation in a fairly constrained portion of the vertical plane. In practice, the emitted radiation output by the “line array” diffusion systems may be likened to a coherent cylindrical wave.

The particular acoustic waveguide disclosed by EP 0 331 566 is generally formed by three distinct elements, two of which are symmetrical with respect to a vertical plane. Such symmetrical elements, when coupled together, define an internal propagation region for acoustic waves, or guiding conduit. Inside the guiding conduit a third element is housed, which is provided in order to transform the input spherical wavefronts into rectangular output wavefronts.

The two symmetrical elements and the third element are designed so that the minimum acoustic paths inside the guiding conduit are rendered uniform (i.e. of substantially equal length). The third element, which has the general shape of a flattened diamond or cone, has to be accurately and precisely fixed inside the guiding conduit, and this does not provide ease of construction to the acoustic waveguide.

Another type of acoustic waveguide comprising internal means for transforming the wavefront of acoustic radiation is described in U.S. Patent Application Publication No. 2003/0188920. In particular in this document an acoustic waveguide is disclosed, which is provided with an internal acoustic lens for transforming the wavefronts of the acoustic radiation propagating inside the guide. More in detail, the acoustic lens is formed by a plurality of transversal plates having a relatively small thickness, i.e. thin plates, which may divide the propagation region into a plurality of acoustic paths, having all approximately the same length. If such transversal plates are to be manufactured by molding, for instance with a metallic material, along with the remaining portion of the acoustic guide, the manufacturing process is comprised of drawbacks due to the relatively small thickness of such plates.

### SUMMARY OF THE INVENTION

An object of the present invention is to provide an acoustic waveguide which represents an alternative to above said acoustic guides of the known art, at the same time allowing its manufacturing by means of a particularly simple and economic process.

This object is achieved by means of an acoustic waveguide An acoustic waveguide includes an internally hollow primary body provided with an opening for an incoming acoustic radiation and an outlet opening for diffusing the radiation to the outside of said guide. The primary body defines an acoustic flared conduit for propagating the radiation between the inlet opening and the outlet opening. The waveguide further includes a plurality of acoustic discontinuity elements inside the acoustic conduit between the inlet opening and the outlet opening, and which are operative to interfere with the radiation propagating inside the acoustic conduit. The plurality of acoustic discontinuity elements include an array of spaced apart pins transverse to the acoustic conduit.

### BRIEF DESCRIPTION OF THE DRAWINGS

Further characteristics and advantages of an acoustic waveguide according to the present invention will become apparent from the following description, with reference to non limiting examples of same, in which:

FIG. 1 shows a perspective oblique view of an acoustic waveguide according to a particularly preferred embodiment of the present invention;

FIG. 2 shows a vertical sectional view of an acoustic waveguide according to FIG. 1,

FIG. 3 shows in further detail a portion of section shown in FIG. 2,

FIG. 4 shows a diagram referring to the experimental measures on the acoustic waveguide of FIG. 1, and

FIG. 5 shows an electroacoustic system comprising two acoustic waveguides of the type shown in FIG. 1.

In the figures, same or like elements have the same numeral references.

### DETAIL DESCRIPTION OF PREFERRED EMBODIMENTS

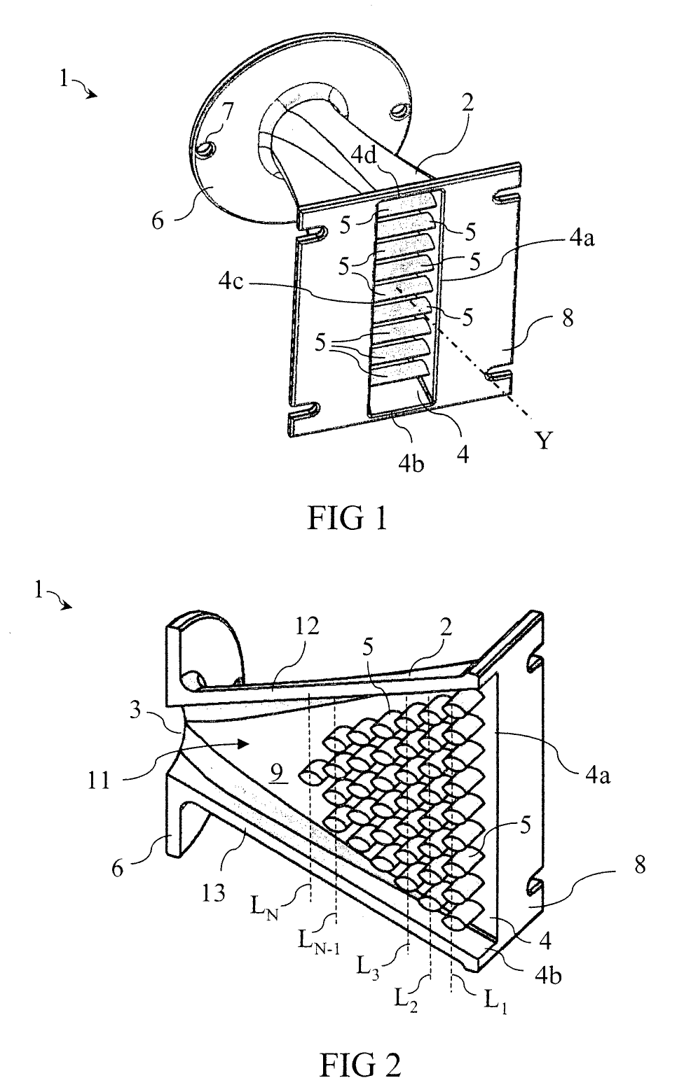

With reference to appended drawings, and in particular to those of FIGS. 1 and 2, an acoustic waveguide according to a particularly preferred embodiment of the present invention is generally shown at 1. Preferably, but in a non-limiting way, such a waveguide is to be used in acoustic diffusion systems, so-called “line-arrays”, and has a frequency characteristic with a lower cut-off frequency of about 1 kHz.

The acoustic waveguide 1 has a internally hollow primary body 2, provided with an inlet opening 3, or throat, and an outlet opening 4, or mouth. The inlet opening 3 allows the coupling of an acoustic incoming radiation into the acoustic guide. In a particularly preferred embodiment, the inlet opening 3 is a generally circular opening, which, by means of a corresponding flange, which is circular in the example shown, may be operatively connected, preferably in a removable way, to an acoustic source (not shown). For example, by means of flange 6, it is possible to operatively connect a compression driver to the inlet opening 3, for instance by means of screws, using corresponding holes 7 provided in flange 6. In a particularly preferred embodiment, the inlet opening 3 is a circular opening having a diameter of about 25 mm.

The outlet opening 4, also known as “mouth” in the technical sector, allows the diffusion towards the outside of the acoustic waveguide 2 of the acoustic radiation coupled into said waveguide. Axis Y of said outlet opening 4 usually defines the propagation direction of acoustic radiation leaving the acoustic waveguide 1.

In a particularly advantageous embodiment, said outlet opening 4 has generally rectangular shape, or “slot”-like shape, with two vertical major sides 4a, 4c and two horizontal minor sides 4b, 4d. Preferably, the major sides 4a and 4c have a dimension at least three times the dimension of minor sides 4b, 4d. More preferably, major sides 4a, 4c are at least four times longer than minor sides 4b, 4d, although a ratio of the major sides 4a, 4c to minor sides 4b, 4d of about 1:1 is acceptable.

In the particular example shown, the outlet opening 4 is surrounded by a front plate 8, which allows the acoustic guide 1 to be fixed to a panel, or more preferably to a terminal horn portion, usually called “bell”. As is known, the function of a bell is to influence the horizontal directivity of the acoustic waveguide 1.

In a particularly advantageous embodiment, as shown in appended figures, major vertical sides 4a, 4c generally extend along almost the whole vertical extension of front plate 8. As a suitable example for the acoustic waveguide 1 shown, the height of plate 8 is approximately 110.6 mm, major side 4a of outlet opening 4 is about 102 mm long, and minor side 4b of outlet opening 4 is about 25 mm long (note 1:4 ratio with respect to major side 4a).

The hollow primary body 2 defines, between inlet opening 3 and outlet opening 4, a flared acoustic conduit 9, which may propagate the acoustic radiation received through opening 3, towards outlet opening 4. This acoustic conduit 9 is shown in FIG. 2, in which the acoustic waveguide 1 of FIG. 1 is shown in a section along a vertical plane containing the axis Y of FIG. 1.

In the particularly preferred embodiment shown in figures, this flared acoustic conduit 9 has an initially circular section which gradually becomes rectangular. Preferably, this flared acoustic conduit 9 is such as to join the circular inlet opening 3 to the major sides 4a, 4c of outlet opening 4, by means of two opposed walls (in FIG. 1, only wall 11 is shown), which are generally parallel to each another and which, preferably near the inlet opening 3, slightly bend towards the interior of acoustic conduit 9, in order to provide a slight choking. Moreover, the flared acoustic conduit 9 is such as to join the inlet opening 3 to the minor sides of outlet opening 4 by means of two mutually inclined walls 12, 13, which, after a flared region opposed to opening 3, become generally perpendicular to opposed parallel walls 22, which in contrast are joined to major sides 4a and 4c of outlet opening 4.

As shown in FIG. 2, the acoustic wave guide 1 inside the acoustic conduit 9 comprises a plurality of discontinuity elements L₁, . . . L_{N}, which may interfere with acoustic radiation propagating inside the acoustic conduit 9. Advantageously, as shown in FIG. 2, the plurality of acoustic discontinuity elements L₁, . . . L_{N}, comprises an array of spaced apart pins 5, transversely positioned with respect to acoustic conduit 9.

In the present description, the phrase “acoustic discontinuity element” encompasses bodies having physical characteristics (shape, dimensions, material) which allow such a body, as it is hit by an acoustic wave propagating inside the acoustic conduit 9, to modify the propagation path of said acoustic wave.

In a particularly preferred embodiment, pins 5 are distributed into rows L₁, . . . L_{N}, of pins. For example, in FIG. 2 it can be noted that pins 5 are placed along N rows (in the example N=7), wherein the first row L₁ comprises nine pins and the N-th row L_{N} (which is a “degenerate” row) comprises only one pin. More preferably, rows L₁, . . . L_{N}, of pins 5 are parallel to each other.

In the particularly preferred embodiment of FIG. 2, rows of pins L₁, . . . L_{N}, comprise an increasing number of pins 5, looking from the inlet opening 3 towards the outlet opening 4.

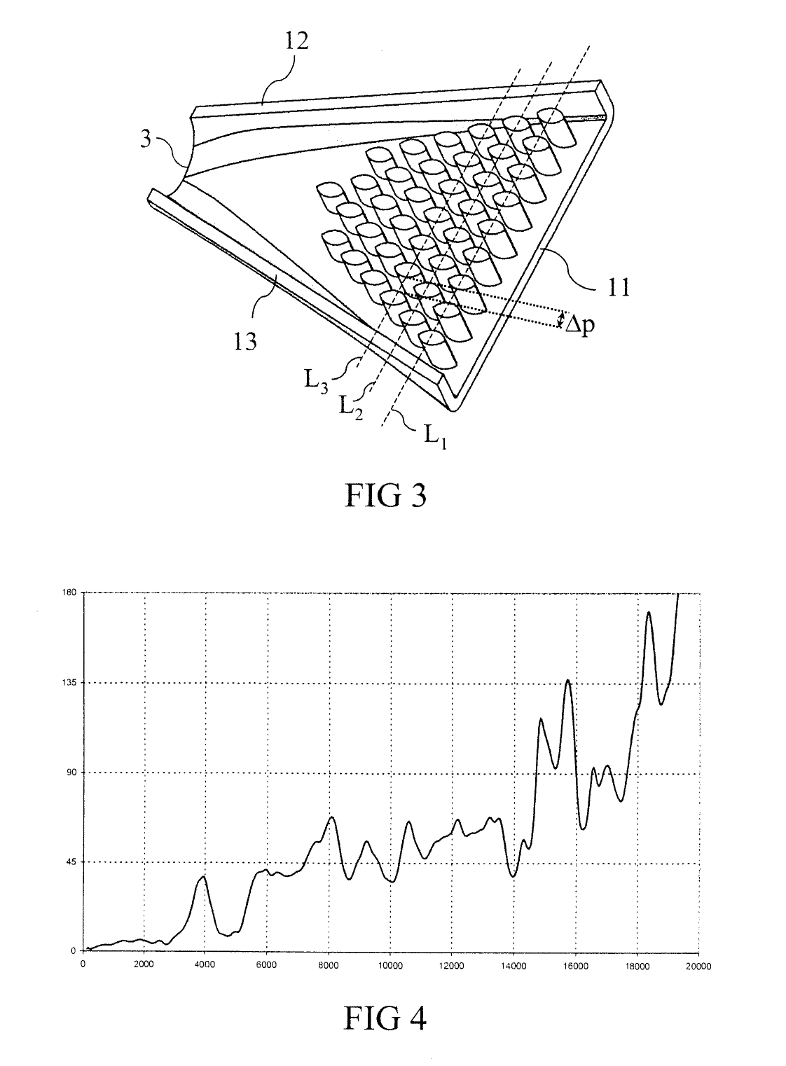

FIG. 3 shows, according to a different direction of observation, a portion of section shown in FIG. 2, in order to show more clearly a particularly preferred though not limiting example of arrangement of pins 5 in rows L₁, . . . L_{N}. As is shown in this example, pins 5 belonging to one row (for example row L₂) are offset with respect to pins 5 of an adjacent row (for example with respect to pins of rows L₃ and L₁ adjacent to row L₂). More preferably, pins 5 belonging to a row (for example L₂) are interlaced with respect to pins 5 of an adjacent row (for example, with respect to rows L₃ and L₁ adjacent to row L₂). Moreover, advantageously, in row L₁, . . . L_{N}, the dimension Δp of sections of pins 5 in a row along the axis of said row is substantially equal to the minimal distance between pins of an adjacent pin row.

In an advantageous embodiment, pins 5 have an external contour formed by two arcs intersecting at two vertices. Preferably, such pins have a substantially “almond”-shaped transversal section.

Pins may have different kind of shapes: for example pins may be provided having a circular, elliptical or diamond shaped section.

The arrangement of pins 5 may be designed in such a way that the array of pins L₁, . . . L_{N}, defines inside the acoustic conduit, between the inlet opening 3 and the outlet opening 4, a plurality of acoustic paths of substantially uniform length.

It is to be noted that the region of acoustic conduit 9, in which the array of pins L₁, . . . L_{N}, is positioned, may be approximated, due to the presence of acoustic discontinuities provided by same pins, to a region of the acoustic conduit 9, in which the propagation velocity of acoustic waves is lower than the propagation velocity of such waves in the remaining part of the acoustic conduit. Preferably, the ratio between these velocities is between 1.1 and 1.4. More preferably, the propagation velocity of waves in the remaining portion of conduit is ca. 1.13 times higher than the propagation velocity in the portion of conduit occupied by the array L₁, . . . Lₙ.

Experimental measures have proved that an array of pins of above said type may define an acoustic lens inside the acoustic conduit, in particular an acoustic lens which is able to transform incoming spherical acoustic wavefronts (such as those output as acoustic radiation by a compression driver) into substantially planar or cylindrical wavefronts. In any case, it is possible to provide, depending on the particular needs, pin arrangements forming an acoustic lens, which cause the wavefronts propagating inside the acoustic conduit 9 to transform in a way, which is different from the particular type of transformation previously described.

With reference to FIGS. 1 and 2, in a particularly advantageous embodiment, the primary body (2) of acoustic guide (1) may be formed by two generally shell-like portions, which are substantially identical, and coupled to each other. For example, each of these portions substantially corresponds to the section of acoustic waveguide 1 of FIG. 2. In this case, each of pins 5 may be comprised of a first pin subpart connected to one of said portions and a second pin subpart connected to the other one of said portions.

These portions may for example be formed by molding, using a metallic material, such as a lightweight aluminum alloy. Alternatively, said portions may be made of molded plastic material. The two portions may then be joined for example by using fixing means, or may be soldered or glued together. Regarding the functionality of the acoustic guide, if, as previously described, each pin is formed by two pin subparts, small interstices between the two pin subparts may be even tolerated, in order to avoid the need of a very precise molding process for manufacturing the two portions.

Experimental tests have shown that an acoustic waveguide according to the present invention, from the functional point of view, provides a valid alternative to above said waveguides of the known art, at the same time requiring only a very simple and economic manufacturing process, such as the molding of two substantially identical parts and their successive gluing.

FIG. 4 shows a diagram regarding experimental measures of the difference of maximum phase (on the ordinate, in degrees), as a function of frequency (on the abscissa, in Hz), between the acoustic waves arriving in eight distinct points, uniformly distributed in front of the outlet opening 4 of acoustic guide 1 and in the near field region. Such measure represents a deviation from the planarity condition of wavefronts output by the acoustic guide 1. As can be deduced by the curve of FIG. 4, it was possible to obtain a maximum phase difference lower than 90° up to 15 kHz. It is to be noted that the condition of constraining the maximum phase under 900 represents one of the requirements for using acoustic waveguides in line-array systems.

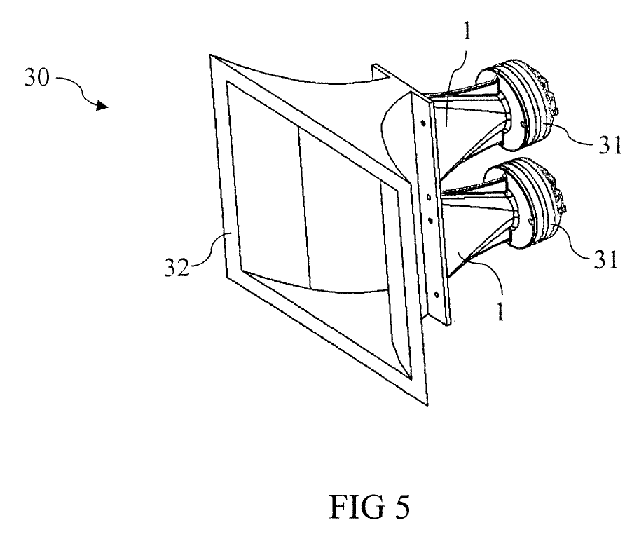

Finally, FIG. 5 shows an example of an electroacoustic system 30, which includes electroacoustic transducers and also acoustic waveguides of the present invention. In this exemplary system 30, two electroacoustic transducers (shown here as compression drivers 31) are each operatively coupled to a respective acoustic waveguide 1 and a bell 32 fixed to the front side of acoustic waveguides 1.

The electroacoustic system 30 may be for instance provided with a resonance box, in order to form an electroacoustic diffuser (possibly including a different type of additional loudspeakers) for use in a diffusion system of the line-array type.

The skilled in the art, in order to meet contingent and specific needs, may obviously introduce various modifications and variants to the above said acoustic wave guide, wherein such modifications and variants are all comprised in the protection scope as defined by the following claims.

1. An acoustic wave guide comprising:
an internally hollow primary body, provided with an opening for an incoming acoustic radiation and an outlet opening for diffusing said radiation to the outside of said guide, the primary body defining an acoustic flared conduit for propagating said acoustic radiation between the inlet opening and the outlet opening,
a plurality of acoustic discontinuity elements provided inside the acoustic conduit between the inlet opening and the outlet opening, such as to interfere with said acoustic radiation propagating inside the acoustic conduit, said plurality of acoustic discontinuity elements comprises an array of spaced apart pins transversal to the acoustic conduit.

2. An acoustic waveguide according to claim 1, wherein said array comprises pins distributed along rows of pins.

3. An acoustic waveguide according to claim 2, wherein said rows of pins are parallel to each other.

4. An acoustic waveguide according to claim 2, wherein said rows of pins have an increasing number of pins, from said inlet opening towards said outlet opening.

5. An acoustic waveguide according to claim 1, wherein in said rows of pins, pins belonging to a row are offset with respect to pins belonging to an adjacent row.

6. An acoustic waveguide according to claim 1, wherein, in said rows of pins, pins belonging to a row are interlaced with respect to pins belonging to an adjacent row.

7. An acoustic waveguide according to claim 6, wherein the dimension of sections of pins in a row along the axis of said row substantially corresponds to the minimal distance between pins of an adjacent row.

8. An acoustic waveguide according to claim 1, wherein said pins have an external contour formed by two arcs intersecting at two vertices.

9. An acoustic waveguide according to claim 1, wherein said pins have a substantially almond-shaped transversal section.

10. An acoustic waveguide according to claim 1, herein the array of pins inside the acoustic conduit defines, between said inlet opening and said outlet opening, a plurality of acoustic paths of substantially equal length.

11. An acoustic waveguide according to claim 1, wherein the region of said acoustic conduit, in which the array is positioned, may be approximated with a conduit region, in which the propagation velocity of acoustic waves is lower than the propagation velocity of said waves in the remaining part of the acoustic conduit.

12. An acoustic waveguide according to claim 11, wherein the ratio between the propagation velocity of acoustic waves in the remaining part of the acoustic conduit and the propagation velocity of said waves in the region in which the array is positioned, is from 1:1 to 1:4.

13. An acoustic waveguide according to claim 12, wherein said ratio is approximately 1:3.

14. An acoustic waveguide according to claim 1, wherein said array of pins defines an acoustic lens inside the acoustic conduit.

15. An acoustic waveguide according to claim 14, wherein said acoustic lens is such as to transform spherical wavefronts of incoming acoustic radiation into substantially planar or cylindrical wavefronts.

16. An acoustic waveguide according to claim 1, wherein said primary body is formed by two substantially identical shell-shaped portions, coupled to each other.

17. An acoustic waveguide according to claim 16, wherein each of pins is formed by a pin subpart connected to one of said parts and by a second pin subpart connected to the other one of said parts.

18. An acoustic waveguide according to claim 1, wherein said outlet opening is a rectangular opening, comprising two minor sides and two major sides, and wherein said pins are perpendicular to said major sides.

19. An acoustic waveguide according to claim 18, wherein said primary body comprises two internal opposed walls, which in proximity of said outlet opening are substantially planar and parallel and are connected to said major sides, respectively, and wherein said pins extend between said internal opposed walls, and are connected to same.

20. An electroacoustic system comprising an electroacoustic transducer and an acoustic waveguide according claim 1, said acoustic guide having said inlet opening operatively coupled to said electroacoustic transducer.

21. An electroacoustic system comprising an electroacoustic transducer and an acoustic waveguide according claim 6, said acoustic guide having said inlet opening operatively coupled to said electroacoustic transducer.

22. An electroacoustic system comprising an electroacoustic transducer and an acoustic waveguide according claim 12, said acoustic guide having said inlet opening operatively coupled to said electroacoustic transducer.

23. Acoustic diffuser system of the “line-array” type, comprising a plurality of acoustic waveguides vertically aligned and configured according to claim 1.

24. Acoustic diffuser system of the “line-array” type, comprising a plurality of acoustic waveguides vertically aligned and configured according to claim 6.

25. Acoustic diffuser system of the “line-array” type, comprising a plurality of acoustic waveguides vertically aligned and configured according to claim 12.
